(19) United States
(12) Patent Application Publication
(10) Pub. No.: US 2015/0256413 A1
(43) Pub. Date: Sep. 10, 2015

(54) NETWORK SYSTEM WITH LIVE TOPOLOGY MECHANISM AND METHOD OF OPERATION THEREOF

(71) Applicant: Sideband Networks Inc., San Jose, CA (US)

(72) Inventors: Jun Du, Cupertino, CA (US); Manas S. Choksi, San Jose, CA (US); Sherman S. Tang, Redondo Beach, CA (US)

(21) Appl. No.: 14/640,939

(22) Filed: Mar. 6, 2015

Related U.S. Application Data
(60) Provisional application No. 61/949,041, filed on Mar. 6, 2014.

(51) Int. Cl. H04L 12/24

(52) U.S. Cl. CPC H04L 41/145; H04L 41/12; H04L 41/0843; H04L 41/0677; H04L 41/0659; H04L 41/0893; H04L 41/065

(57) ABSTRACT

A network system includes a control unit, configured to inspect one or more live network packets including one or more live data packets and live service packets being transmitted through a network; generate a topology model for mapping the network based on topology attributes obtained from the live network packets; generate a live topology representing the network based on the topology model and the live network packets; and a communication interface, coupled to the control unit, configured to communicate the live topology to a device.

### CROSS-REFERENCE TO RELATED APPLICATION(S)

This application claims the benefit of U.S. Provisional Patent Application Ser. No. 61/949,041 filed Mar. 6, 2014, the subject matter of which is hereby incorporated by reference herein.

### TECHNICAL FIELD

An embodiment of the present invention relates generally to a network system, and more particularly to a network system with a live topology mechanism.

### BACKGROUND

Modern consumer and industrial electronics, especially networked devices such as cellular phones, tablet devices, network-enabled appliances, enterprise servers, switches, routers, firewalls, or a combination thereof are providing increasing levels of functionality to support modern life. Research and development in the existing technologies can take a myriad of different directions.

As users become more empowered with the prevalence of these networked devices, new and old paradigms begin to take advantage of this new technology space. However, the tools available to today's network administrators are often as complex as the networks themselves.

Thus, a need still remains for a network system with a live topology mechanism appropriate for today's networking environment. In view of the ever-increasing commercial competitive pressures, along with growing client expectations and the diminishing opportunities for meaningful product differentiation in the marketplace, it is increasingly critical that answers be found to these problems.

Additionally, the need to reduce costs, improve efficiencies and performance, and meet competitive pressures adds an even greater urgency to the critical necessity for finding answers to these problems. Solutions to these problems have been long sought but prior developments have not taught or suggested any solutions and, thus, solutions to these problems have long eluded those skilled in the art.

### SUMMARY

An embodiment of the present invention provides a network system including a control unit, configured to inspect one or more live network packets including one or more live data packets and live service packets being transmitted through a network; generate a topology model for mapping the network based on topology attributes obtained from the live network packets; generate a live topology representing the network based on the topology model and the live network packets; and a communication interface, coupled to the control unit, configured to communicate the live topology to a device.

An embodiment of the present invention provides a method of operation of a network system including inspecting, with a control unit, one or more live network packets including one or more live data packets and live service packets being transmitted through a network; generating a topology model for mapping the network based on topology attributes obtained from the live network packets; generating a live topology representing the network based on the topology model and the live network packets; and communicating, with a communication interface coupled to the control unit, the live topology to a device.

An embodiment of the present invention provides a non-transitory computer readable medium including inspecting one or more live network packets including one or more live data packets and live service packets being transmitted through a network; generating a topology model for mapping the network based on topology attributes obtained from the live network packets; generating a live topology representing the network based on the topology model and the live network packets; and communicating the live topology to a device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a network system with a live topology mechanism in an embodiment of the present invention.

FIG. 2 is an example block diagram of the network system.

FIG. 3 is an example display interface of the network system.

FIG. 4 is another example display interface of the network system.

FIG. 5 is yet another example display interface of the network system.

FIG. 6 is a control flow of the network system.

FIG. 7 is a flow chart of a method of operation of the network system in a further embodiment of the present invention.

### DETAILED DESCRIPTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “module” referred to herein can include software, hardware, or a combination thereof in the embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof. Further, if a module is written in the apparatus claims sections below, the modules are deemed to include hardware circuitry for the purposes and the scope of the apparatus claims.

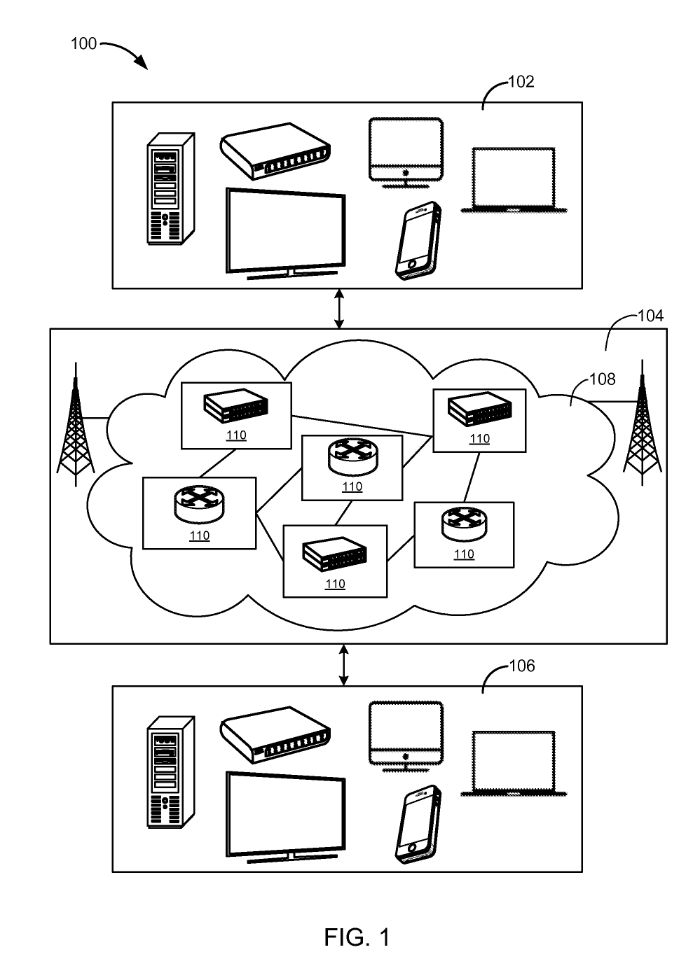

Referring now to FIG. 1, therein is shown a network system 100 with a live topology mechanism in an embodiment of the present invention. The network system 100 includes a first device 102 connected to a second device 106. The first device 102 can communicate with the second device 106 through a communication path 104.

For illustrative purposes, the network system 100 is described with the first device 102 as a computing device with a display interface, although it is understood that the first device 102 can be different types of devices. The first device 102 can be any of a variety of centralized or decentralized computing devices. For example, the first device 102 can be a particularized machine, such as a networking device having a display interface.

As a more specific example, the first device 102 can be a router, a switch, a software defined network compatible switch, a metadata-driven switch, or a combination thereof. The first device 102 can also be a mainframe, a server, a cluster server, a rack mounted server, a blade server, or a combination thereof.

The first device 102 can be centralized in a single room, distributed across different rooms, distributed across different geographical locations, embedded within a telecommunications network, or a combination thereof. For example, the first device 102 can be a grid-computing resource, a virtualized computing resource, a cloud computing resource, a peer-to-peer distributed computing device, or a combination thereof.

The first device 102 can also be any of a variety of mobile devices, such as a laptop computer, a tablet device, a smartphone, a cellular phone, or a combination thereof. The first device 102 can couple with the communication path 104 to communicate with the second device 106.

For illustrative purposes, the network system 100 is described with the second device 106 as a computing device with a display interface, although it is understood that the second device 106 can also be different types of devices. The second device 106 can be any of a variety of centralized or decentralized computing devices. For example, the second device 106 can also be a particularized machine, such as a networking device having a display interface.

As a more specific example, the second device 106 can be a router, a switch, a software-defined network compatible switch, a metadata-driven switch, or a combination thereof. The second device 106 can also be a mainframe, a server, a cluster server, a rack mounted server, a blade server, or a combination thereof.

The second device 102 can be centralized in a single room, distributed across different rooms, distributed across different geographical locations, embedded within a telecommunications network, or a combination thereof. For example, the second device 106 can be a grid-computing resource, a virtualized computing resource, a cloud computing resource, a peer-to-peer distributed computing device, or a combination thereof.

The second device 106 can also be any of a variety of mobile devices, such as a laptop computer, a tablet device, a smartphone, a cellular phone, or a combination thereof. The second device 106 can couple with the communication path 104 to communicate with the first device 102.

Also for illustrative purposes, the network system 100 is shown with the second device 106 and the first device 102 as end points of the communication path 104, although it is understood that the network system 100 can have a different partition between the first device 102, the second device 106, and the communication path 104. For example, the first device 102, the second device 106, or a combination thereof can also function as part of the communication path 104.

The communication path 104 can be a variety of networks or communication mediums. For example, the communication path 104 can include wireless communication, wired communication, optical communication, or a combination thereof. Satellite communication, cellular communication, Bluetooth™, Bluetooth™ Low Energy (BLE), wireless High-Definition Multimedia Interface (HDMI), ZigBee™, Near Field Communication (NFC), Infrared Data Association standard (IrDA), wireless fidelity (WiFi), and worldwide interoperability for microwave access (WiMAX) are examples of wireless communication that can be included in the communication path 104. Ethernet, HDMI, digital subscriber line (DSL), fiber to the home (FTTH), and plain old telephone service (POTS) are examples of wired communication that can be included in the communication path 104.

The first device 102, the second device 106, or a combination thereof can couple, either directly or indirectly, to a network 108. The network 108 can include a personal area network (PAN), a local area network (LAN), a metropolitan area network (MAN), a wide area network (WAN), a software defined network, a virtual local area network (VLAN), a Virtual Extensible local area network (VxLAN), a Multiprotocol Label Switching (MPLS) network, a Generic Routing Encapsulation (GRE) network, a Network Virtualization using Generic Routing Encapsulation (NvGRE) network, a portion therein, or a combination thereof.

The network 108 can include a number of network components 110. The network components 110 can include any variety of networking devices or networked-appliances, such as routers, switches, peer-to-peer distributed computing devices, virtualized switches, virtualized routers, display devices, home appliances, commercial appliances, or a combination thereof.

The network components 110 can also include any variety of mobile devices such as mobile phones, tablet devices, laptop computers, wearable devices, or a combination thereof. The network components 110 can further include any variety of centralized or decentralized computing resources, such as desktop computers, multimedia computers, grid-computing resources, cloud-computing resources, virtualized computing resources, or a combination thereof. It should be understood that the network components 110 can include the first device 102, the second device 106, a portion therein, or a combination thereof.

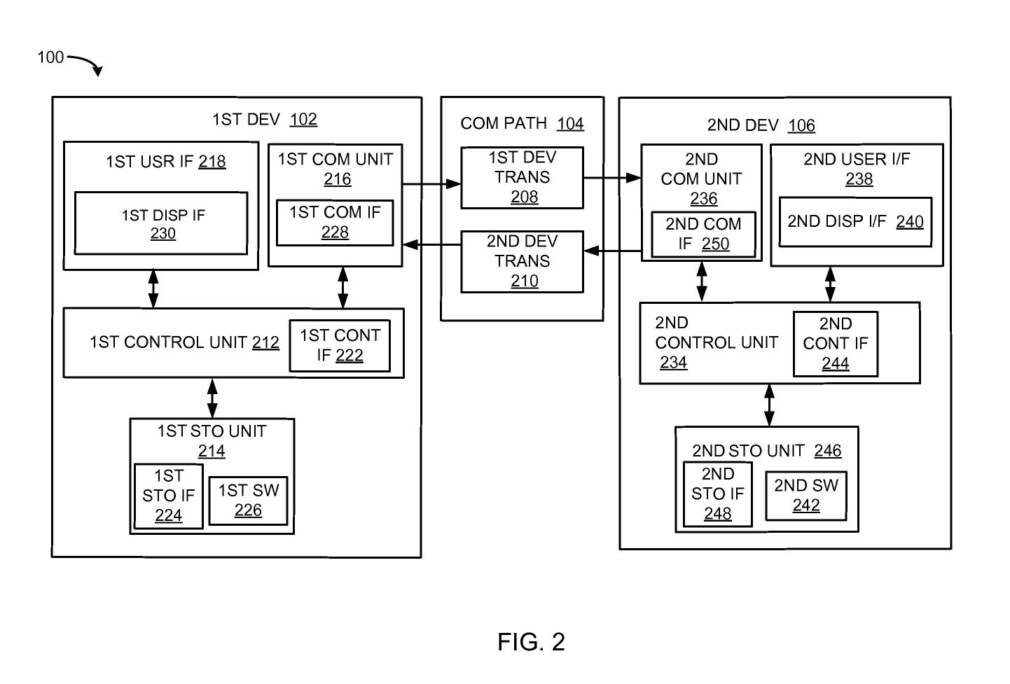

Referring now to FIG. 2, therein is shown an exemplary block diagram of the network system 100. The network system 100 can include the first device 102, the communication path 104, and the second device 106. Although the network 108 of FIG. 1 and the network components 110 of FIG. 1 are not shown in FIG. 2, it should be understood that the exemplary blocks illustrated in the diagram can be used to depict a part of the network 108, the network components 110, or a combination thereof.

For example, the exemplary block diagram of the first device 102, the second device 106, or a combination thereof can represent one of the network components 110. In addition, the communication path 104 can include a portion of the network 108 and information can be transmitted through the network 108 similar to how it is transmitted through the communication path 104.

The first device 102 can send information in a first device transmission 208 over the communication path 104 to the second device 106. The second device 106 can send information in a second device transmission 210 over the communication path 104 to the first device 102.

For brevity of description in this embodiment of the present invention, the first device 102 will be described as a networking device and the second device 106 will be described as a host device. Embodiments of the present invention are not limited to this selection for the type of devices. The selection is an example of the embodiments of the present invention.

The first device 102 can include a first control unit 212, a first storage unit 214, a first communication unit 216, and a first user interface 218. The first control unit 212 can include a first control interface 222. The first control unit 212 can execute a first software 226 to provide the intelligence of the network system 100. The first control unit 212 can be implemented in a number of different manners.

For example, the first control unit 212 can be a processor, an embedded processor, a microprocessor, a hardware control logic, a hardware finite state machine (FSM), a digital signal processor (DSP), or a combination thereof. The first control interface 222 can be used for communication between the first control unit 212 and other functional units in the first device 102. The first control interface 222 can also be used for communication that is external to the first device 102.

The first control interface 222 can receive information from the other functional units or from external sources, or can transmit information to the other functional units or to external destinations. The external sources and the external destinations refer to sources and destinations external to the first device 102.

The first control interface 222 can be implemented in different ways and can include different implementations depending on which functional units or external units are being interfaced with the first control interface 222. For example, the first control interface 222 can be implemented with a pressure sensor, an inertial sensor, a microelectromechanical system (MEMS), optical circuitry, waveguides, wireless circuitry, wireline circuitry, or a combination thereof.

The first storage unit 214 can store the first software 226. The first storage unit 214 can also store relevant information, such as advertisements, biometric information, points of interest (POIs), navigation routing entries, reviews/ratings, feedback, or any combination thereof.

The first storage unit 214 can be a volatile memory, a nonvolatile memory, an internal memory, an external memory, or a combination thereof. For example, the first storage unit 214 can be a nonvolatile storage such as non-volatile random access memory (NVRAM), Flash memory, disk storage, or a volatile storage such as static random access memory (SRAM).

The first storage unit 214 can include a first storage interface 224. The first storage interface 224 can be used for communication between the first storage unit 214 and other functional units in the first device 102. The first storage interface 224 can also be used for communication that is external to the first device 102.

The first storage interface 224 can receive information from the other functional units or from external sources, or can transmit information to the other functional units or to external destinations. The external sources and the external destinations refer to sources and destinations external to the first device 102.

The first storage interface 224 can include different implementations depending on which functional units or external units are being interfaced with the first storage unit 214. The first storage interface 224 can be implemented with technologies and techniques similar to the implementation of the first control interface 222.

The first communication unit 216 can enable external communication to and from the first device 102. For example, the first communication unit 216 can permit the first device 102 to communicate with the second device 106 of FIG. 1, an attachment such as a peripheral device or a notebook computer, and the communication path 104.

The first communication unit 216 can also function as a communication hub allowing the first device 102 to function as part of the communication path 104 and not limited to be an end point or terminal unit to the communication path 104. The first communication unit 216 can include active and passive components, such as microelectronics or an antenna, for interaction with the communication path 104.

The first communication unit 216 can include a first communication interface 228. The first communication interface 228 can be used for communication between the first communication unit 216 and other functional units in the first device 102. The first communication interface 228 can receive information from the other functional units or can transmit information to the other functional units.

The first communication interface 228 can include different implementations depending on which functional units are being interfaced with the first communication unit 216. The first communication interface 228 can be implemented with technologies and techniques similar to the implementation of the first control interface 222.

The first user interface 218 allows a user (not shown) to interface and interact with the first device 102. The first user interface 218 can include an input device and an output device. Examples of the input device of the first user interface 218 can include a microphone, a keypad, a touchpad, soft-keys, a keyboard, or any combination thereof to provide data and communication inputs.

Examples of the output device of the first user interface 218 can include a first display interface 230. The first display interface 230 can include a display, a projector, a video screen, a speaker, or any combination thereof.

The first control unit 212 can operate the first user interface 218 to display information generated by the network system 100. The first control unit 212 can also execute the first software 226 for the other functions of the network system 100. The first control unit 212 can further execute the first software 226 for interaction with the communication path 104 via the first communication unit 216.

The second device 106 can be optimized for implementing the various embodiments in a multiple device embodiment with the first device 102. The second device 106 can provide the additional or higher performance processing power compared to the first device 102. The second device 106 can include a second control unit 234, a second communication unit 236, and a second user interface 238.

The second user interface 238 allows the user to interface and interact with the second device 106. The second user interface 238 can include an input device and an output device. Examples of the input device of the second user interface 238 can include a microphone, a keypad, a touchpad, soft-keys, a keyboard, or any combination thereof to provide data and communication inputs. Examples of the output device of the second user interface 238 can include a second display interface 240. The second display interface 240 can include a display, a projector, a video screen, a speaker, or any combination thereof.

The second control unit 234 can execute a second software 242 to provide the intelligence of the second device 106 of the network system 100. The second software 242 can operate in conjunction with the first software 226. The second control unit 234 can provide additional performance compared to the first control unit 212.

The second control unit 234 can operate the second user interface 238 to display information. The second control unit 234 can also execute the second software 242 for the other functions of the network system 100, including operating the second communication unit 236 to communicate with the first device 102 over the communication path 104.

The second control unit 234 can be implemented in a number of different manners. For example, the second control unit 234 can be a processor, an embedded processor, a microprocessor, a hardware control logic, a hardware finite state machine (FSM), a digital signal processor (DSP), or a combination thereof.

The second control unit 234 can include a second controller interface 244. The second controller interface 244 can be used for communication between the second control unit 234 and other functional units in the second device 106. The second controller interface 244 can also be used for communication that is external to the second device 106.

The second controller interface 244 can receive information from the other functional units or from external sources, or can transmit information to the other functional units or to external destinations. The external sources and the external destinations refer to sources and destinations external to the second device 106.

The second controller interface 244 can be implemented in different ways and can include different implementations depending on which functional units or external units are being interfaced with the second controller interface 244. For example, the second controller interface 244 can be implemented with a pressure sensor, an inertial sensor, a microelectromechanical system (MEMS), optical circuitry, waveguides, wireless circuitry, wireline circuitry, or a combination thereof.

A second storage unit 246 can store the second software 242. The second storage unit 246 can also store the relevant information, such as advertisements, biometric information, points of interest, navigation routing entries, reviews/ratings, feedback, or any combination thereof. The second storage unit 246 can be sized to provide the additional storage capacity to supplement the first storage unit 214.

For illustrative purposes, the second storage unit 246 is shown as a single element, although it is understood that the second storage unit 246 can be a distribution of storage elements. Also for illustrative purposes, the network system 100 is shown with the second storage unit 246 as a single hierarchy storage system, although it is understood that the network system 100 can have the second storage unit 246 in a different configuration. For example, the second storage unit 246 can be formed with different storage technologies forming a memory hierarchal system including different levels of caching, main memory, rotating media, or off-line storage.

The second storage unit 246 can be a volatile memory, a nonvolatile memory, an internal memory, an external memory, or a combination thereof. For example, the second storage unit 246 can be a nonvolatile storage such as non-volatile random access memory (NVRAM), Flash memory, disk storage, or a volatile storage such as static random access memory (SRAM).

The second storage unit 246 can include a second storage interface 248. The second storage interface 248 can be used for communication between the second storage unit 246 and other functional units in the second device 106. The second storage interface 248 can also be used for communication that is external to the second device 106.

The second storage interface 248 can receive information from the other functional units or from external sources, or can transmit information to the other functional units or to external destinations. The external sources and the external destinations refer to sources and destinations external to the second device 106.

The second storage interface 248 can include different implementations depending on which functional units or external units are being interfaced with the second storage unit 246. The second storage interface 248 can be implemented with technologies and techniques similar to the implementation of the second controller interface 244.

The second communication unit 236 can enable external communication to and from the second device 106. For example, the second communication unit 236 can permit the second device 106 to communicate with the first device 102 over the communication path 104.

The second communication unit 236 can also function as a communication hub allowing the second device 106 to function as part of the communication path 104 and not limited to be an end point or terminal unit to the communication path 104. The second communication unit 236 can include active and passive components, such as microelectronics or an antenna, for interaction with the communication path 104.

The second communication unit 236 can include a second communication interface 250. The second communication interface 250 can be used for communication between the second communication unit 236 and other functional units in the second device 106. The second communication interface 250 can receive information from the other functional units or can transmit information to the other functional units.

The second communication interface 250 can include different implementations depending on which functional units are being interfaced with the second communication unit 236. The second communication interface 250 can be implemented with technologies and techniques similar to the implementation of the second controller interface 244.

The first communication unit 216 can couple with the communication path 104 to send information to the second device 106 in the first device transmission 208. The second device 106 can receive information in the second communication unit 236 from the first device transmission 208 of the communication path 104.

The second communication unit 236 can couple with the communication path 104 to send information to the first device 102 in the second device transmission 210. The first device 102 can receive information in the first communication unit 216 from the second device transmission 210 of the communication path 104. The network system 100 can be executed by the first control unit 212, the second control unit 234, or a combination thereof.

For illustrative purposes, the second device 106 is shown with the partition having the second user interface 238, the second storage unit 246, the second control unit 234, and the second communication unit 236, although it is understood that the second device 106 can have a different partition. For example, the second software 242 can be partitioned differently such that some or all of its function can be in the second control unit 234 and the second communication unit 236. Also, the second device 106 can include other functional units not shown in FIG. 2 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the network system 100 is described by operation of the first device 102 and the second device 106. It is understood that the first device 102 and the second device 106 can operate any of the modules and functions of the network system 100.

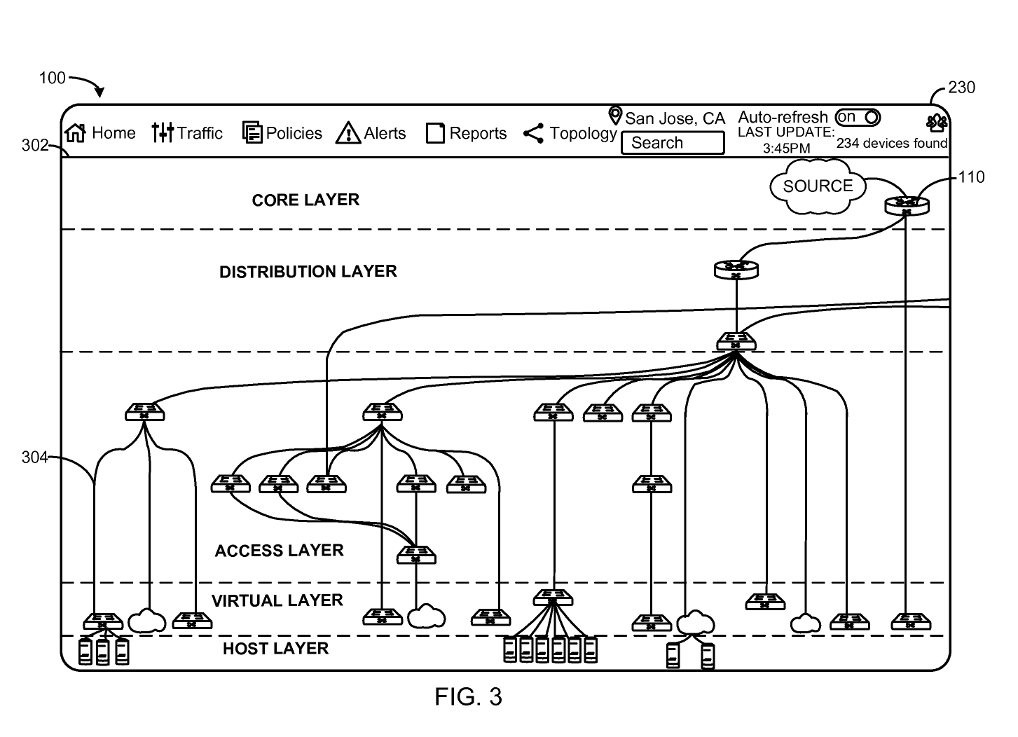

Referring now to FIG. 3, therein is shown an example display interface 230 of the network system 100. The display interface 230 can depict a live topology 302 of the network 108 of FIG. 1. The live topology 302 is a dynamic display of an arrangement of the network components 110 in the network 108 and links 304 connecting the network components 110. The live topology 302 can be arranged into multiple layers. The multiple layers can group the network components 110 by device functionality, device location, or a combination thereof.

The multiple layers can include a core layer, a distribution layer, an access layer, a virtual layer, a host layer, or a combination thereof. In addition, the multiple layers can include an Open Systems Interconnection (OSI) model layer, a Transmission Control Protocol (TCP)/Internet Protocol (IP) layer, or a combination thereof. As a more specific example, the live topology 302 can be divided into a data link layer, a network layer, or a combination thereof.

The live topology 302 can depict one or more host devices in the host layer. The host devices can include computing devices, such as mobile devices, laptop computers, desktop computers, virtual machines, or a combination thereof. The host devices can be used by users of the network system 100 to access services or traffic provided by the network 108.

The live topology 302 can also depict a source of the network traffic. The source can include a public network, a private network, a computing device in the public network, a computing device in the private network, or a combination thereof. For example, the source can include part of a WAN, such as the Internet.

The links 304 are communication pathways connecting one instance of the network components 110 with another instance of the network components 110. The links 304 can include a physical link, a link, a signal link, a wireless link, a virtual link, or a combination thereof. The links 304 can include the communication pathways in the communication path 104 of FIG. 1. The links 304 can be represented on the live topology 302 using lines, arrows, symbols, or a combination thereof.

For illustrative purposes, the live topology 302 is shown being depicted using the first device 102 of FIG. 1, although it is understood that the live topology 302 can also be displayed on a different device. For example, the live topology 302 can be depicted using the second device 106 of FIG. 1 or another device in the network 108. The same instance of the live topology 302 can also be displayed on a plurality of the network components 110 simultaneously.

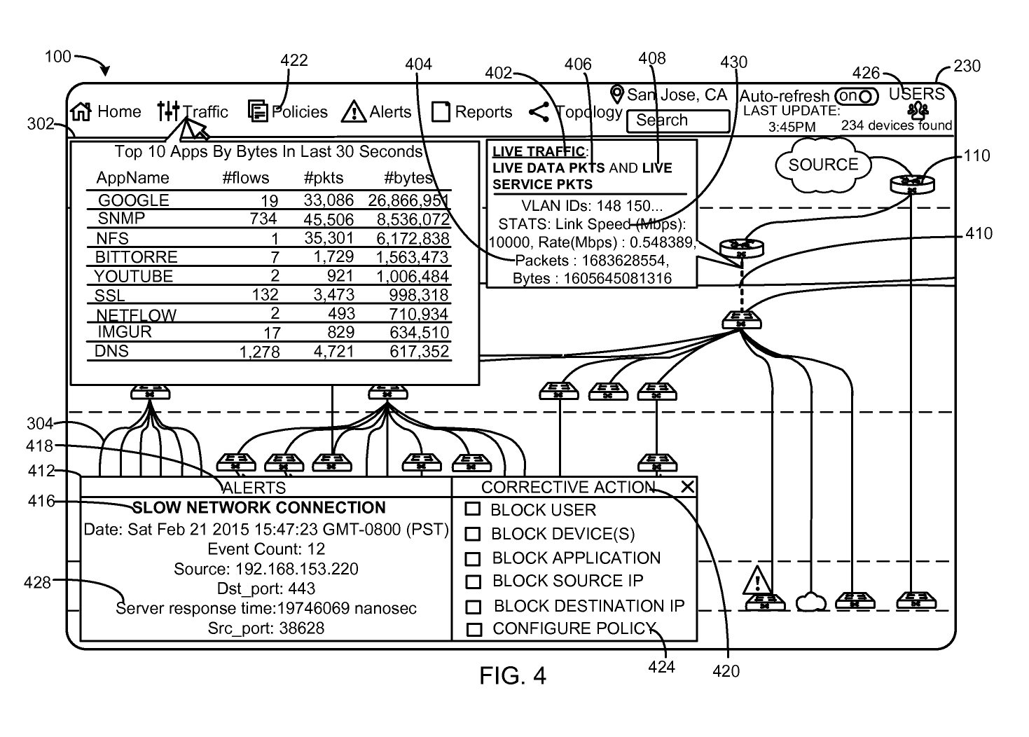

Referring now to FIG. 4, therein is shown another example display interface 230 of the network system 100. The display interface 230 can depict live traffic flow 402 on the live topology 302. The live traffic flow 402 is a representation of the flow of network traffic over the links 304 of the live topology 302. The live traffic flow 402 can represent the flow of live network packets 404 over the links 304 of the live topology 302.

The live network packets 404 are packets presently being transmitted over the network 108 without reaching a host destination intended for the packets. The live network packets 404 can be packets presently traversing a wired or wireless connection in the network 108. The live network packets 404 can be packets associated with a hypertext transfer protocol (HTTP) session, a simple network management protocol (SNMP) session, a domain name system (DNS) session, a file transfer protocol (FTP) session, a Telnet session, a transmission control protocol (TCP) session, an Internet Protocol (IP) session, or a combination thereof.

The live network packets 404 can include live data packets 406 and live service packets 408. The live data packets 406 are instances of the live network packets 404 carrying application content or data. For example, the live data packets 406 can include packets received from any application involving OSI layer functionalities. As a more specific example, the live data packets 406 can include packets received as part of a Facebook™ session or a Netflix™ session. As another example, the source can be a Facebook™ server or a Netflix™ server and the live data packets 406 can include packets carrying a multimedia content. In addition, the live data packets 406 can include email data from an email server.

The live service packets 408 are instances of the live network packets 404 carrying routing, forwarding, management information, or a combination thereof. For example, the live service packets 408 can include Address Resolution Protocol (ARP) packets, Link Layer Discovery Protocol (LLDP)/Cisco™ Discovery Protocol (CDP) packets, Simple Network Management Protocol (SNMP) packets, Dynamic Host Configuration Protocol (DHCP) packets, Domain Name System (DNS) packets, Spanning Tree Protocol (STP) packets, Open Shortest Path First (OSPF) packets, Border Gateway Protocol (BGP) packets, routing packets, or a combination thereof. The live service packets 408 can include information on where to forward or direct the live data packets 406.

The live topology 302 can depict a transmission path 410 of the live network packets 404. The transmission path 410 is a connection route used by the live network packets 404 for reaching a host destination. The transmission path 410 of the live network packets 404 can include multiple instances of the links 304 connecting a source of the live network packets 404 with the host destination.

The network system 100 can display an overlay window 412 on the live topology 302. The overlay window 412 provides visibility and functionality related to the network 108. The overlay window 412 can be implemented as a message window, a modal window, a pop-up window, or a combination thereof. The overlay window 412 can include a visual element, an audio element, or a combination thereof. The overlay window 412 can inform a user, such as network administrator, of calculations or determinations made by the various modules of the network system 100.

As depicted in FIG. 4, the overlay window 412 can communicate an alert 418 concerning a network anomaly 416. The alert 418 is a notification for informing a user of the network 108 such as a network administrator of the network anomaly 416. The network anomaly 416 is a network usage behavior deviating from a pattern of usage previously established by a user or a device in the network 108. The network anomaly 416 can deviate from the established pattern of usage by a statistically significant amount. For example, the network anomaly 416 can deviate from the established pattern of usage by two standard deviations or more.

In addition, the overlay window 412 can also communicate a corrective action 420 for addressing the network anomaly 416. The corrective action 420 is a procedure for removing or reducing the effect of the network anomaly 416 on the proper functioning of the network 108. The corrective action 420 can be an action or command for bringing the network 108 into compliance with a network policy 422, a network rule, or a combination thereof.

The network policy 422 is an agreement concerning the proper functioning of the network 108. The corrective action 420 can include a policy change 424 of the network policy 422. The policy change 424 is a command or action for changing a portion of the network policy 422 currently in place. The network policy 422 can include a service level agreement (SLA) policy, a quality of service (QoS) policy, or a combination thereof. For example, the policy change 424 can include one or more actions or commands for instituting a bandwidth cap associated with a QoS policy.

The electronic system 100 can generate the live topology 302 based on user attributes 426, device attributes 428, traffic attributes 430, or a combination thereof. The user attributes 426 are identities or characteristics of one or more users of the network 108. The user attributes 426 can include a credential, a title, an occupation, a permission level, or a combination there of a user of the network 108.

The device attributes 428 are identities or characteristics of the network components 110 on the network 108. The device attributes 428 can include the capability or compatibility of one or more hardware or software components of the network components 110. The device attributes 428 can also include a specification of one or more hardware components or software components included as part of the network components 110. The device attributes 428 can also include configuration information concerning the network components 110.

For example, the device attributes 428 can include the identities of a device or component manufacturer or vendor. As an additional example, the device attributes 428 can include the frequency of firmware updates to the network components 110.

The traffic attributes 430 are rates, measurements, or identifiers concerning the flow of traffic in the network 108. The traffic attributes 430 can include a link speed, a switching or routing rate, a destination IP, a source IP, or a combination thereof. The traffic attributes 430 can also include the number or size of an application flow.

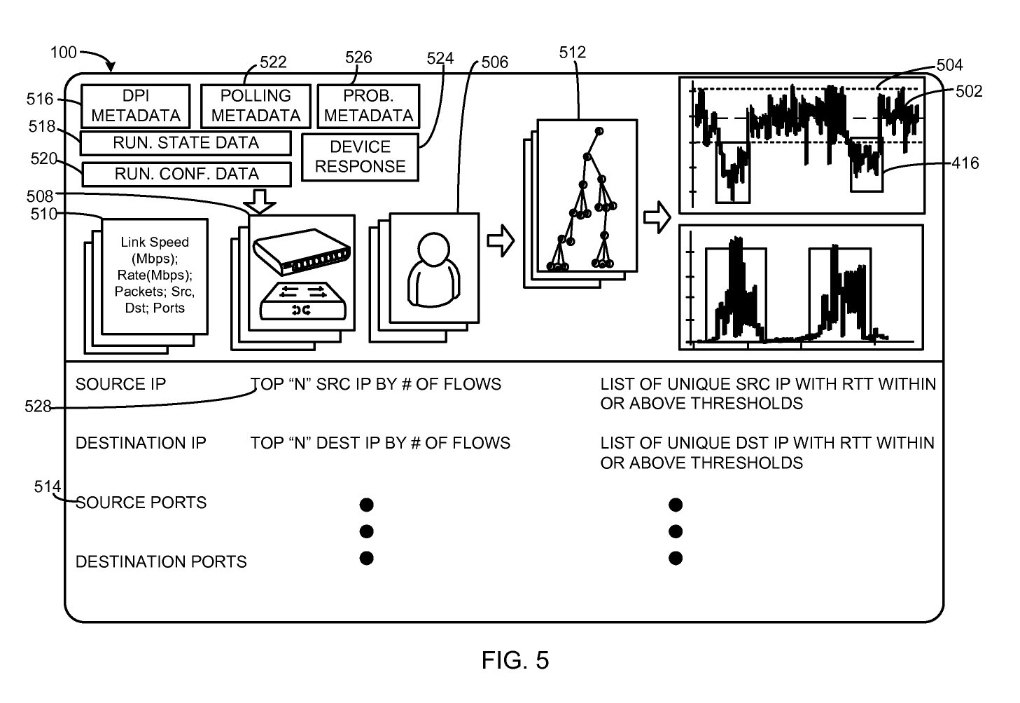

Referring now to FIG. 5, therein is shown yet another example display interface 230 of the network system 100. The display interface 230 can depict one or more modeled behaviors 502 of the network 108 of FIG. 1, the network components 110 of FIG. 1, the live traffic flow 402 of FIG. 4, or a combination thereof. The modeled behaviors 502 are trends or patterns detected from an analysis of the network 108.

The modeled behaviors 502 can be operational trends or patterns detected from an analysis of the network components 110 in the network 108. The modeled behaviors 502 can also be usage trends or patterns detected from an analysis of the users on the network 108. In addition, the modeled behaviors 502 can be flow patterns detected from analysis of the traffic in the network 108.

As depicted in FIG. 5, the modeled behaviors 502 can be within a threshold range 504. The threshold range 504 is a set of bounding values for representing the limits of an established behavior or pattern. The threshold range 504 can include a max value, a min value, or a combination thereof. As will be discussed below, the electronic system 100 can use the threshold range 504 and the modeled behaviors 502 to determine the network anomaly 416.

The display interface 230 can also depict one or more user models 506, device models 508, traffic models 510, or a combination thereof. The user models 506 are data structures or simulations representing the behavior of users on the network 108. The user models 506 can include data structures or simulations generated over time. The user models 506 can be implemented as functions, tables, arrays, or a combination thereof.

The device models 508 are data structures or simulations representing the behavior of devices on the network 108. The device models 508 can include data structures or simulations generated over time. The device models 508 can be implemented as functions, tables, arrays, or a combination thereof. For example, the device models 508 can represent the behavior of the network components 110 over time.

The traffic models 510 are data structures or simulations representing the behavior of traffic transmitted over the network 108. The traffic models 510 can include data structures or simulations generated over time. The traffic models 510 can be implemented as functions, tables, arrays, or a combination thereof.

The display interface 230 can also depict a topology model 512. The topology model 512 is a collection of data representing the arrangement of the network components 110 in the network 108 and the links 304 of FIG. 3 connecting the network components 110. The topology model 512 can be generated based on topology attributes 514. The topology attributes 514 are identifying information concerning a connectivity of the network 108. The topology attributes 514 can include identifying information concerning a source port, a destination port, or a combination thereof. The electronic system 100 can inspect a header of the live network packets 404 of FIG. 4 to obtain the topology attributes 514.

The user models 506, the device models 508, and the traffic models 510 can be generated from DPI metadata 516, running state data 518, running configuration data 520, polling metadata 522, probing metadata 526, a device response 524, or a combination thereof.

The DPI metadata 516 is contextual or descriptive data concerning an inspection performed on the live data packets 406. The running state data 518 is data concerning an active operation of the network components 110. The running configuration data 520 is data concerning an active configuration of the network components 110.

The polling metadata 522 is contextual or descriptive data concerning a poll of the network components 110. The polling metadata 522 can include a time interval between configuration polls, the types of configuration tables accessed, or a combination thereof.

The probing metadata 526 is contextual or descriptive data concerning a probe of the network components 110. The device response 524 is a response of one or more of the network components 110 to a probe of the network components 110.

As will be discussed below, the electronic system 100 can generate an aggregate data 528 by collecting data or metadata concerning a device, a user, or a traffic flow in the network 108. The electronic system 100 can generate the aggregate data 528 by collecting or aggregating the DPI metadata 516, the running state data 518, the running configuration data 520, the polling metadata 522, the probing metadata 526, the device response 524, or a combination thereof.

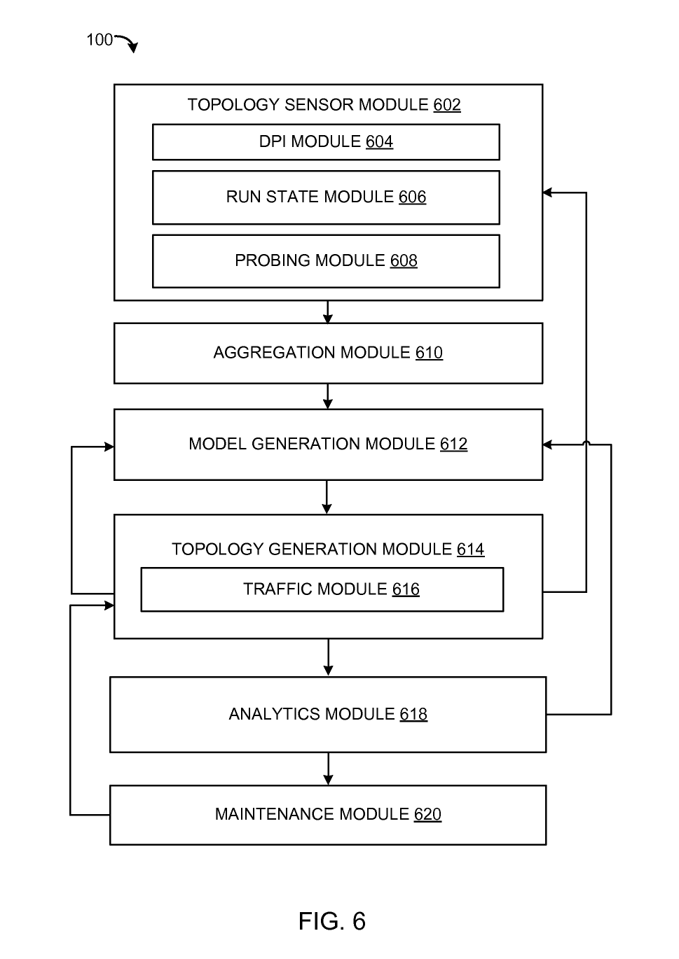

Referring now to FIG. 6, therein is shown a control flow of the network system 100. The network system 100 can include a topology sensor module 602, an aggregation module 610, a model generation module 612, a topology generation module 614, an analytics module 618, a maintenance module 620, or a combination thereof.

The modules can be coupled by having the input of one module connected to the output of another module as shown in FIG. 5. The modules can be coupled by using wired or wireless connections, the communication path 104 of FIG. 1, instructional steps, or a combination thereof. The modules can be coupled directly, without any intervening structures other than the structure providing the direct connection. The modules can further be coupled indirectly, through a shared connection or other functional structures between the coupled modules.

The topology sensor module 602 is configured to inspect the live network packets 404 of FIG. 4 being transmitted through the network 108 of FIG. 1. The topology sensor module 602 can inspect the live data packets 406 of FIG. 4, the live service packets 408 of FIG. 4, or a combination thereof. The topology sensor module 602 can inspect the live network packets 404 for obtaining information concerning the network 108. The topology sensor module 602 can also inspect the live network packets 404 for obtaining information concerning the identity, status, or connectivity of the network components 110 of FIG. 1.

The topology sensor module 602 can be initiated when the first device 102 of FIG. 1, the second device 106 of FIG. 1, or a combination thereof is coupled to the network 108. For example, the topology sensor module 602 can be initiated when a switch or a virtual switch representing the first device 102 is coupled to one of the network components 110.

The topology sensor module 602 can include a deep packet inspection (DPI) module 604, a run state module 606, a probing module 608, or a combination thereof. The DPI module 604 is configured to perform an inspection of the live network packets 404. The DPI module 604 can perform an inspection of the live network packets 404 in a number of ways.

For example, the DPI module 604 can perform an inspection of the payloads or headers of the live network packets 404 transmitted through the network 108. Also, for example, the DPI module 604 can perform an inspection of the live network packets 404 by tapping or mirroring a port of one of the network components 110. As another example, the DPI module 604 can perform an inspection of the live network packets 404 by tapping a connection between two of the network components 110 such as a wired or wireless connection. As an additional example, the DPI module 604 can perform an inspection of the live network packets 404 by filtering or intercepting the live network packets 404.

The DPI module 604 can perform an inspection of the live network packets 404 by utilizing a networking protocol. For example, the DPI module 604 can perform an inspection of the live network packets 404 using an Address Resolution protocol, a Link Layer Discovery protocol, a Cisco™ Discovery protocol, a Simple Network Management protocol, a Dynamic Host Configuration protocol, a Domain Name System protocol, a Spanning Tree protocol, an Open Shortest Path First protocol, a Border Gateway protocol, or a combination thereof.

The DPI module 604 can also generate the DPI metadata 516 of FIG. 5. The DPI module 604 can generate the DPI metadata 516 for providing additional information concerning the inspection of the live network packets 404.

As previously discussed, the DPI metadata 516 can include descriptive data, contextual data, relational data, or a combination thereof concerning the inspection of the live network packets 404. For example, the DPI metadata 516 can include a time of inspection, a percentage of the payload inspected, or a combination thereof.

The DPI module 604 can be part of the first software 226 of FIG. 2, the second software 242 of FIG. 2, or a combination thereof. The first control unit 212 of FIG. 2 can execute the first software 226, the second control unit 234 of FIG. 2 can execute the second software 242, or a combination thereof to inspect the live network packets 404 and generate the DPI metadata 516. The DPI module 604 can use the first storage unit 214 of FIG. 2, the second storage unit 246 of FIG. 2, or a combination thereof to store the DPI metadata 516 and select instances of the live network packets 404 after the inspection.

The DPI module 604 can also be implemented as hardware circuitry or hardware accelerators in the first control unit 212, the second control unit 234, or a combination thereof. In addition, the DPI module 604 can also be implemented as hardware circuitry or hardware accelerators in the first device 102, the second device 106, or a combination thereof but outside of the first control unit 212, the second control unit 234, or a combination thereof.

Moreover, the DPI module 604 can also communicate the results of the inspection, the DPI metadata 516, or a combination thereof to other modules in the control flow or other devices of the electronic system 100 through the first communication unit 216 of FIG. 2, the second communication unit 236 of FIG. 2, or a combination thereof. After inspecting the live network packets 404 and generating the DPI metadata 516, the control flow can pass from the DPI module 604 to the run state module 606.

The run state module 606 is configured to poll the network components 110 for the running state data 518 of FIG. 5, the running configuration data 520 of FIG. 5, or a combination thereof. The run state module 606 can poll the network components 110 for determining a level of activity presently in the network 108 at the time of polling.

The run state module 606 can poll the network components 110 for the running state data 518 by requesting information concerning an active operation of the network components 110. For example, one of the network components 110 can be a switch and the run state module 606 can poll the switch for a traffic load handled by one or more ports of the switch.

The run state module 606 can also poll the network components 110 for the running configuration data 520. The run state module 606 can poll the network components 110 for the running configuration data 520 by requesting a device configuration. For example, the run state module 606 can poll a switch or router for a port configuration.

The run state module 606 can poll the network components 110 by accessing a routing table, an address table, a forwarding table, or a combination thereof on the network components 110. The run state module 606 can poll the network components 110 on a periodic basis. In addition, the run state module 606 can poll the network components 110 when triggered by an event such as a policy violation, a network breach, or network latency.

The run state module 606 is also configured to generate the polling metadata 522 of FIG. 5. The run state module 606 can generate the polling metadata 522 for providing additional information concerning the polling of the network components 110. The polling metadata 522 can include descriptive data, contextual data, relational data, or a combination thereof concerning the polling of the network components 110. For example, the polling metadata 522 can include a time interval between configuration polls, the types of configuration tables accessed, or a combination thereof.

The run state module 606 can be part of the first software 226, the second software 242, or a combination thereof. The first control unit 212 can execute the first software 226, the second control unit 234 can execute the second software 242, or a combination thereof to poll the network components 110 for the running state data 518, the running configuration data 520, or a combination thereof and generate the polling metadata 522. The run state module 606 can use the first storage unit 214, the second storage unit 246, or a combination thereof to store the running state data 518, the running configuration data 520, the polling metadata 522, or a combination thereof.

The run state module 606 can also be implemented as hardware circuitry or hardware accelerators in the first control unit 212, the second control unit 234, or a combination thereof. In addition, the run state module 606 can also be implemented as hardware circuitry or hardware accelerators in the first device 102, the second device 106, or a combination thereof but outside of the first control unit 212, the second control unit 234, or a combination thereof.

Moreover, the run state module 606 can also communicate the running state data 518, the running configuration data 520, the polling metadata 522, or a combination thereof to other modules in the control flow or other devices of the electronic system 100 through the first communication unit 216, the second communication unit 236, or a combination thereof. After polling the network components 110 for the running state data 518, the running configuration data 520, or a combination thereof and generating the polling metadata 522, the control flow can pass from the run state module 606 to the probing module 608.

The probing module 608 is configured to probe the network components 110. The probing module 608 can probe the network components 110 for proactively determining the identity, health, status, or a combination thereof of the network components 110. For example, the probing module 608 can probe a router in the network 108 to proactively determine the health or status of the router.

The probing module 608 can probe the network components 110 by sending a probing packet to one or more of the network components 110. The probing packet can include a connection request packet, a customized service packet or a combination thereof.

The probing module 608 can proactively probe the network components 110 to elicit the device response 524 of FIG. 5. The probing module 608 can examine the device response 524 to determine whether the device response 524 is in accordance with the expected outcome of the probing packet. For example, the probing module 608 can send a service request to a router in the network 108 and observe the device response 524 of the router to the service request.

The probing module 608 can also generate the probing metadata 526 of FIG. 5. The probing module 608 can generate the probing metadata 526 for providing additional information concerning the probe of the network components 110. The probing metadata 526 can include descriptive data, contextual data, relational data, or a combination thereof concerning the probing of the network components 110. For example, the probing metadata 526 can include a timing of probe requests, a response time or date, a response delay, or a combination thereof.

The probing module 608 can be part of the first software 226, the second software 242, or a combination thereof. The first control unit 212 can execute the first software 226, the second control unit 234 can execute the second software 242, or a combination thereof to probe the network components 110 to elicit the device response 524 and generate the probing metadata 526. The probing module 608 can use the first storage unit 214, the second storage unit 246, or a combination thereof to store the device response 524, the probing metadata 526, or a combination thereof.

The probing module 608 can also be implemented as hardware circuitry or hardware accelerators in the first control unit 212, the second control unit 234, or a combination thereof. In addition, the probing module 608 can also be implemented as hardware circuitry or hardware accelerators in the first device 102, the second device 106, or a combination thereof but outside of the first control unit 212, the second control unit 234, or a combination thereof.

Moreover, the probing module 608 can also communicate the device response 524, the probing metadata 526, or a combination thereof to other modules in the control flow or other devices of the electronic system 100 through the first communication unit 216, the second communication unit 236, or a combination thereof. After probing the network components 110 and generating the probing metadata 526, the control flow can pass from the probing module 608 and the topology sensor module 602 to the aggregation module 610.

The aggregation module 610 is configured to generate the aggregate data 528 of FIG. 5. The aggregation module 610 can generate the aggregate data 528 by collecting data or metadata according to one or more networking attributes such as the device attributes 428 of FIG. 4, the user attributes 426 of FIG. 4, the traffic attributes 430 of FIG. 4, the topology attributes 514 of FIG. 5, or a combination thereof.

The aggregation module 610 can generate the aggregate data 528 by collecting data or metadata obtained from the topology sensor module 602 such as the DPI metadata 516, the polling metadata 522, the probing metadata 526, the running state data 518, the running configuration data 520, the device response 524 or a combination thereof according to the networking attributes. In addition, the aggregation module 610 can generate the aggregate data 528 by collecting data or metadata obtained from the inspection of the live network packets 404 according to the device attributes 428, the user attributes 426, the traffic attributes 430, the topology attributes 514, or a combination thereof.

The device attributes 428, the user attributes 426, the traffic attributes 430, the topology attributes 514, or a combination thereof can be predetermined by the electronic system 100. In addition, the attributes can be received from another device or selected from a user input.

The aggregation module 610 can generate the aggregate data 528 by applying rules, triggers, conditional statements, clusters, training sets, or a combination thereof to the data or information obtained from the topology sensor module 602. The aggregation module 610 can save the aggregate data 528 in a relational database, an array database, a key-value database, a columnar database, an object orientated database, hash tables, data trees, or a combination thereof. For example, the aggregation module 610 can save the aggregate data 528 as JavaScript Object Notation (JSON) data trees.

For example, the aggregate data 528 can include the number of bytes of data being transmitted through the network 108 for a particular user, host device, or a combination thereof. As an additional example, the aggregate data 528 can include the number of flows of application traffic associated with a particular IP address.

The aggregation module 610 can be part of the first software 226, the second software 242, or a combination thereof. The first control unit 212 can execute the first software 226, the second control unit 234 can execute the second software 242, or a combination thereof to generate the aggregate data 528. The aggregation module 610 can use the first storage unit 214, the second storage unit 246, or a combination thereof to store the aggregate data 528.

The aggregation module 610 can also be implemented as hardware circuitry or hardware accelerators in the first control unit 212, the second control unit 234, or a combination thereof. In addition, the aggregation module 610 can also be implemented as hardware circuitry or hardware accelerators in the first device 102, the second device 106, or a combination thereof but outside of the first control unit 212, the second control unit 234, or a combination thereof.

Moreover, the aggregation module 610 can also communicate the aggregate data 528 to other modules in the control flow or other devices of the electronic system 100 through the first communication unit 216, the second communication unit 236, or a combination thereof. After generating the aggregate data 528, the control flow can pass from the aggregation module 610 to the model generation module 612.

The model generation module 612 is configured to generate the user models 506 of FIG. 5, the device models 508 of FIG. 5, the traffic models 510 of FIG. 5, and the topology model 512 of FIG. 5. The model generation module 612 can generate the topology model 512 for mapping the locations and connections of the network components 110 in the network 108. The model generation module 612 can generate the user models 506, the device models 508, and the traffic models 510 for tracking the behaviors of users, devices, and traffic, respectively, on the network 108.

The model generation module 612 can generate the user models 506 using the aggregate data 528 collected according to the user attributes 426. As previously discussed, the user attributes 426 can include the credentials, permission levels, or demographics of one or more users on the network 108.

The model generation module 612 can generate the user models 506 by classifying or sorting the aggregate data 528 collected according to the user attributes 426. For example, the model generation module 612 can generate the user models 506 by ranking the top one hundred applications accessed by users with a certain security clearance over time. As an additional example, the model generation module 612 can generate the user models 506 by calculating the application flows associated with a particular user over a period of time.

The model generation module 612 can generate the device models 508 using the aggregate data 528 collected according to the device attributes 428. The model generation module 612 can generate the device models 508 by classifying or sorting the aggregate data 528 collected according to the device attributes 428.

For example, the model generation module 612 can generate the device models 508 by classifying or sorting the network components 110 by functionality, physical location, throughput capability, or a combination thereof. As a more specific example, the model generation module 612 can generate one of the device models 508 as the network components 110 with a combined L2 and L3 switching capability.

As an additional example, the model generation module 612 can generate another one of the device models 508 as the total throughput of the network components 110 with a particular network interface card. As yet another example, the model generation module 612 can generate one of the device models 508 as all of the network components 110 in a particular enterprise office.

The model generation module 612 can generate the traffic models 510 using the aggregate data 528 collected according to the traffic attributes 430. The model generation module 612 can generate the traffic models 510 by classifying or sorting the aggregate data 528 collected according to the traffic attributes 430.

For example, the model generation module 612 can generate the traffic models 510 by ranking the network components 110 with a traffic throughput above 10 Gigabytes per second (Gbps) over time. Also, for example, the model generation module 612 can generate the traffic models 510 by determining a distribution of the live data packets 406 and the live service packets 408 according to a source IP, a destination IP, or a combination thereof. As an additional example, the model generation module 612 can generate the traffic models 510 by determining the distribution of traffic associated with a particular application.

The model generation module 612 can generate the topology model 512 using the aggregate data 528 collected according to the topology attributes 514. The model generation module 612 can generate the topology model 512 by classifying or sorting the aggregate data 528 collected according to the topology attributes 514.

The model generation module 612 can generate the topology model 512 by generating a table of connections between network components 110 in the network 108. For example, the model generation module 612 can generate one of the device models 508 as a table listing all parent and child connections in the network 108.

The model generation module 612 can generate the topology model 512 based on the user models 506, the device models 508, the traffic models 510, or a combination thereof. The model generation module 612 can generate the topology model 512 for mapping the network 108 based on the topology attributes 514 obtained from the aggregate data 528 including the live data packets 406, the live service packets 408, or a combination thereof. The model generation module 612 can generate the topology model 512 as a composite model including portions of the user models 506, the device models 508, and the traffic models 510.

The model generation module 612 can generate the topology model 512 by first determining the identities of all active or functioning instances of the network components 110 in the network 108. The model generation module 612 can use the device models 508 to determine the identities of all active or functioning instances of the network components 110 in the network 108.

After determining the identities of the network components 110, the model generation module 612 can determine the links 304 of FIG. 3 connecting the network components 110 in the network 108. The model generation module 612 can determine the links 304 connecting the network components 110 based on the topology attributes 514 obtained from the live data packets 406, the live service packets 408, or a combination thereof.

For example, the model generation module 612 can determine the links 304 based on information concerning a source port, a destination port, or combination thereof obtained from a header of the live data packets 406. Also, for example, the model generation module 612 can determine the links 304 based on a handshake procedure between two instances of the network components 110 obtained from the live service packets 408.

The model generation module 612 can generate the topology model 512 by generating a table or data tree of the links 304 connecting the network components 110. The topology model 512 can also include information concerning the geographic or physical locations of the network components 110. For example, the topology model 512 can include information concerning the locations of switches or routers in the network 108. In addition, the topology model 512 can include information concerning the network services areas covered by the network 108. For example, the topology model 512 can include information concerning the number of personal area networks (PANs), LANs, residential area networks (RANs), metropolitan area networks (MANs), or a combination thereof covered by the network 108.

The model generation module 612 can update the user models 506, the device models 508, the traffic models 510, the topology model 512, or a combination thereof as new information concerning the network 108 becomes available. For example, the device models 508 can be updated as new devices are added to the network 108. As an additional example, the user models 506 can be updated as new users join the network 108.

The user models 506, the device models 508, the traffic models 510, the topology model 512, or a combination thereof can be implemented as one or more tables, arrays, databases, data structures, functions, or a combination thereof. For example, the user models 506, the device models 508, the traffic models 510, the topology model 512, or a combination thereof can be implemented using hash tables, key-value databases, object-oriented databases, metadata-based models, or a combination thereof. In the case of the metadata-based models, the information collected by the topology generation module 614 can be implemented as JavaScript Object Notation (JSON) data trees embedded with Lisp functions.

After the model generation module 612 generates the topology model 512, the control flow can pass back to the topology sensor module 602 to provide feedback to the topology sensor module 602. The feedback can be used by the topology sensor module 602 to fine-tune the inspection of the live network packets 404.

For example, the topology sensor module 602 can adjust the inspection of the live network packets 404 by the DPI module 604, the polling of the running state data 518 or the running configuration data 520 by the run state module 606, the probing of the network components 110 by the probing module 608, or a combination thereof based on the feedback. As a more specific example, the DPI module 604 can use the feedback to adjust the inspection of the live network packets 404 to capture as much of the live network packets 404 flowing through the network 108 as possible.

The model generation module 612 can be part of the first software 226, the second software 242, or a combination thereof. The first control unit 212 can execute the first software 226, the second control unit 234 can execute the second software 242, or a combination thereof to generate the user models 506, the device models 508, the traffic models 510, the topology model 512, or a combination thereof. The model generation module 612 can use the first storage unit 214, the second storage unit 246, or a combination thereof to store the user models 506, the device models 508, the traffic models 510, the topology model 512, or a combination thereof.

The model generation module 612 can also be implemented as hardware circuitry or hardware accelerators in the first control unit 212, the second control unit 234, or a combination thereof. In addition, the model generation module 612 can also be implemented as hardware circuitry or hardware accelerators in the first device 102, the second device 106, or a combination thereof but outside of the first control unit 212, the second control unit 234, or a combination thereof.

Moreover, the model generation module 612 can also communicate the user models 506, the device models 508, the traffic models 510, the topology model 512, or a combination thereof to other modules in the control flow or other devices of the electronic system 100 through the first communication unit 216, the second communication unit 236, or a combination thereof. After generating the user models 506, the device models 508, the traffic models 510, the topology model 512, or a combination thereof, the control flow can pass from the model generation module 612 to the topology generation module 614.

The topology generation module 614 is configured to generate the live topology 302 of FIG. 3. The topology generation module 614 can generate the live topology 302 for dynamically representing activity on the network 108. The topology generation module 614 can generate the live topology 302 using device and connectivity information from the device models 508, the traffic models 510, and the topology model 512.

The topology generation module 614 can generate the live topology 302 by graphically representing the network components 110 active in the network 108. In addition, the topology generation module 614 can generate the live topology 302 by graphically representing the links 304 between the network components 110. The live topology 302 can be depicted using a variety of markup or scripting languages or tools. For example, the live topology 302 can be implemented using any combination of HyperText Markup Language (HTML), Cascading Style Sheets (CSS), Extensible Markup Language (XML), JavaScript, or a combination thereof.

The topology generation module 614 can depict the live topology 302 in a top-down hierarchical structure. For example, the topology generation module 614 can generate the live topology 302 by depicting the network components 110 performing a core routing function in a core layer at the top of the live topology 302. In addition, the topology generation module 614 can depict the network components 110 serving as destinations for the live network packets 404 in a host layer at the bottom of the live topology 302.

The topology generation module 614 can also generate additional layers of the live topology 302 in between the core layer and the host layer. For example, the live topology 302 can include a distribution layer, an access layer, a virtual layer, or a combination thereof in between the core layer and the host layer.

The topology generation module 614 can also update the live topology 302 based on updates or changes to the user models 506, the device models 508, the traffic models 510, the topology model 512, or a combination thereof. The topology generation module 614 can update the live topology 302 based on new inspections of the live network packets 404 and new instances of the running configuration data 520, the running state data 518, the DPI metadata 516, the polling metadata 522, the probing metadata 526, the device response 524, or a combination thereof.

The topology generation module 614 can include a traffic module 616. The traffic module 616 is configured to make viewable the live traffic flow 402 of FIG. 4 on the live topology 302. The live traffic flow 402 can represent the transmission of the live data packets 406, the live service packets 408, or a combination thereof over the network 108.

The traffic module 616 can make viewable the live traffic flow 402 by first determining the transmission path 410 of FIG. 4 of the live network packets 404. The traffic module 616 can determine the transmission path 410 of the live network packets 404 by interacting with the topology sensor module 602 to inspect the headers of the live network packets 404. In addition, the traffic module 616 can determine the transmission path 410 of the live network packets 404 by inspecting the traffic models 510, the topology model 512, or a combination thereof.

After determining the transmission path 410, the traffic module 616 can make viewable the live traffic flow 402 by displaying one or more icons, images, or graphics representing the transmission path 410 on the links 304 of FIG. 3 of the live topology 302. For example, the traffic module 616 can make viewable the live traffic flow 402 by highlighting one or more of the links 304 traversed by the live network packets 404. As a more specific example, the traffic module 616 can make viewable the live traffic flow 402 associated with a Netflix™ streaming session by highlighting the links 304 traversed by the Netflix™ application packets.

The traffic module 616 can also make viewable the live traffic flow 402 by generating an instance of the overlay window 412 of FIG. 4 concerning the live traffic flow 402. The traffic module 616 can generate the overlay window 412 based on an event trigger, a user input, or a combination thereof. The traffic module 616 can generate the overlay window 412 for providing information concerning the live traffic flow 402.

For example, the traffic module 616 can receive a cursor input or a touch input on one of the links 304 shown in the live topology 302. In this example, the traffic module 616 can generate the overlay window 412 to provide information concerning the live traffic flow 402 over the link selected. As a more specific example, the traffic module 616 can generate the overlay window 412 to communicate a link speed, a flow rate, the number of packets or the number of bytes delivered over the link, or a combination thereof.

The topology generation module 614 can be part of the first software 226, the second software 242, or a combination thereof. The first control unit 212 can execute the first software 226, the second control unit 234 can execute the second software 242, or a combination thereof to generate the live topology 302 including the live traffic flow 402. The topology generation module 614 can use the first storage unit 214, the second storage unit 246, or a combination thereof to store the live topology 302.

The topology generation module 614 can also be implemented as hardware circuitry or hardware accelerators in the first control unit 212, the second control unit 234, or a combination thereof. In addition, the topology generation module 614 can also be implemented as hardware circuitry or hardware accelerators in the first device 102, the second device 106, or a combination thereof but outside of the first control unit 212, the second control unit 234, or a combination thereof.

Moreover, the topology generation module 614 can also communicate the live topology 302 to other modules in the control flow or other devices of the electronic system 100 through the first communication unit 216 including the first communication interface 228 of FIG. 2, the second communication unit 236 including the second communication interface 238 of FIG. 2, or a combination thereof. After generating the live topology 302, the control flow can pass from the topology generation module 614 to the analytics module 618.

The analytics module 618 is configured to determine the network anomaly 416 of FIG. 4 associated with the network 108. The analytics module 618 can determine the network anomaly 416 for detecting a violation of the network policy 422 of FIG. 4, network rules, or a combination thereof. In addition, the analytics module 618 can determine the network anomaly 416 for determining an effect of the network anomaly 416 on the proper functioning of the network 108. The analytics module 618 can determine the network anomaly 416 by calculating the modeled behaviors 502 of FIG. 5.

The analytics module 618 can calculate the modeled behaviors 502 by applying a statistical analysis procedure to the user models 506, the device models 508, the traffic models 510, or a combination thereof. The analytics module 618 can apply the statistical analysis procedure to the user models 506, the device models 508, the traffic models 510, or a combination thereof to determine a pattern of usage associated with a device or a user and a flow pattern associated with the network traffic.

The analytics module 618 can calculate the modeled behaviors 502 by applying a probability function, an entropy function, a threshold function, or a combination thereof to the user models 506, the device models 508, the traffic models 510, or a combination thereof. The analytics module 618 can use as inputs the device attributes 428, the user attributes 426, or the traffic attributes 430 included as part of the device models 508, the user models 506, or the traffic models 510, respectively.

The analytics module 618 can then calculate the threshold range 504 of FIG. 5 from the modeled behaviors 502. The analytics module 618 can calculate the threshold range 504 for representing an established or expected pattern of usage. The analytics module 618 can calculate the threshold range 504 by calculating average values, median values, variances, min-max values, or a combination thereof associated with the modeled behaviors 502.

After calculating the modeled behaviors 502 and the threshold range 504, the analytics module 618 can calculate new instances of the modeled behaviors 502. The analytics module 618 can calculate new instances of the modeled behaviors 502 by applying the statistical analysis procedure to new instances of the user models 506, the device models 508, the traffic models 510, or a combination thereof. The new instances of the user models 506, the device models 508, the traffic models 510, or a combination thereof can be generated from an inspection of new instances of the live network packets 404 being transmitted through the network 108.

The analytics module 618 can determine the network anomaly 416 when the new instances of the modeled behaviors 502 are calculated to be outside of the threshold range 504. The analytics module 618 can use a maximum entropy function, a sigma clipping function, or a combination thereof to determine the network anomaly 416.

The analytics module 618 can also determine the network components 110 associated with the network anomaly 416. The analytics module 618 can determine the network components 110 associated with the network anomaly 416 by tracing the network anomaly 416 to one or more of the network components 110 involved in causing the network anomaly 416.

For example, the analytics module 618 can determine a host device as being associated with the network anomaly 416 of a slow connection when the host device is accessing a video streaming application prohibited by the network 108. Also, for example, the analytics module 618 can determine a router as being associated with the network anomaly 416 of network latency when one or more ports of the router are down for maintenance.

The analytics module 618 can interact with the topology generation module 614 to communicate the network anomaly 416 through the live topology 302. The analytics module 618 can interact with the topology generation module 614 to display the alert 418 of FIG. 4. The analytics module 618 can display the alert 418 for identifying the network components 110 associated with the network anomaly 416. The alert 418 can include a graphical icon, a pop-up window, or a combination thereof indicating the detection of the network anomaly 416 in the network 108. The analytics module 618 can also generate an instance of the overlay window 412 for communicating the network anomaly 416.

The analytics module 618 can be part of the first software 226, the second software 242, or a combination thereof. The first control unit 212 can execute the first software 226, the second control unit 234 can execute the second software 242, or a combination thereof to determine the network anomaly 416. The analytics module 618 can use the first storage unit 214, the second storage unit 246, or a combination thereof to store information concerning the network anomaly 416.

The analytics module 618 can also be implemented as hardware circuitry or hardware accelerators in the first control unit 212, the second control unit 234, or a combination thereof. In addition, the analytics module 618 can also be implemented as hardware circuitry or hardware accelerators in the first device 102, the second device 106, or a combination thereof but outside of the first control unit 212, the second control unit 234, or a combination thereof.

Moreover, the analytics module 618 can also communicate the network anomaly 416 to other modules in the control flow or other devices of the electronic system 100 through the first communication unit 216, the second communication unit 236, or a combination thereof. After determining the network anomaly 416, the control flow can pass from the analytics module 618 to the maintenance module 620.

The maintenance module 620 is configured to generate the corrective action 420 of FIG. 4. The maintenance module 620 can generate the corrective action 420 in order to address the network anomaly 416. The maintenance module 620 can generate the corrective action 420 based on the user models 506, the device models 508, and the traffic models 510.

The corrective action 420 can include one or more commands, rules, policies, configurations, or a combination thereof for addressing the network anomaly 416. For example, the corrective action 420 can include a command or a rule to block one or more users, devices, applications, source IPs, destination IPs, or a combination thereof. As an additional example, the corrective action 420 can include a command or a rule to re-route the live network packets 404 affected by the network anomaly 416 through different instances of the network components 110 and the links 304.

The maintenance module 620 can apply the corrective action 420 automatically to the network 108. In addition, the maintenance module 620 can apply the corrective action 420 after receiving an input from a user such as a network administrator. The maintenance module 620 can apply the corrective action 420 by interfacing with the network components 110. The maintenance module 620 can interface with the network components 110 through an Application Programming Interface (API), a command line interface (CLI), or a combination thereof. The maintenance module 620 can also interface with a network controller (not shown) coupled to the network 108 to carry out or push down commands needed to implement the corrective action 420.

For example, the maintenance module 620 can apply a command to block network traffic originating from an IP address by interfacing with a router to include the IP address in an access blacklist or removing the IP address from an access control list of the router. Also, for example, the maintenance module 620 can communicate the corrective action 420 through the overlay window 412.

The maintenance module 620 can receive a user input such as a click-input, a touch gesture, or a selection input through the overlay window 412 to apply the corrective action 420 to one or more of the network components 110. In addition, the maintenance module 620 can receive the user input through the live topology 302. For example, the maintenance module 620 can change the transmission path 410 of the live network packets 404 when the user clicks or selects a different instance of the links 304 on the live topology 302.

The maintenance module 620 can also identify the policy change 424 of FIG. 4 for changing or reconfiguring the network policy 422 of the network 108. The maintenance module 620 can identify the policy change 424 when the user inputs the policy change 424 through the overlay window 412. In addition, the maintenance module 620 can identify the policy change 424 when the maintenance module 620 receives the policy change 424 from a device in the network 108. The maintenance module 620 can apply the policy change 424 to the network 108 thorough the live topology 302.

The maintenance module 620 can apply the policy change 424 by interfacing with one or more of the network components 110. For example, the maintenance module 620 can apply the policy change 424 through a Secure Shell (SSH) protocol, a Telnet protocol, or a combination thereof.

The maintenance module 620 can be part of the first software 226, the second software 242, or a combination thereof. The first control unit 212 can execute the first software 226, the second control unit 234 can execute the second software 242, or a combination thereof to generate and apply the corrective action 420. The maintenance module 620 can use the first storage unit 214, the second storage unit 246, or a combination thereof to store information concerning the corrective action 420.

The maintenance module 620 can also be implemented as hardware circuitry or hardware accelerators in the first control unit 212, the second control unit 234, or a combination thereof. In addition, the maintenance module 620 can also be implemented as hardware circuitry or hardware accelerators in the first device 102, the second device 106, or a combination thereof but outside of the first control unit 212, the second control unit 234, or a combination thereof.

Moreover, the maintenance module 620 can also communicate the corrective action 420 to other modules in the control flow or other devices of the electronic system 100 through the first communication unit 216, the second communication unit 236, or a combination thereof. After generating and applying the corrective action 420, the control flow can pass back to the topology generation module 614 to update the live topology 302 based on changes to the network 108 as a result of the corrective action 420. For example, the topology generation module 614 can update the live topology 302 based on the policy change 424 applied to the network 108.

Generating the live topology 302 and displaying the live topology 302 on a display interface such as the first display interface 230, the second display interface 240, or a combination thereof results in movement in the physical world, such as network administrators using the live topology 302 to manipulate or redirect network traffic including the live network packets 404. As the movement in the physical world occurs, the movement itself generates additional instances of the live topology 302 and to continued movement in the physical world.

It has been discovered that generating the topology model 512 based on the topology attributes 514 obtained from the live network packets 404 provides for a more accurate representation of the topology of the network 108. Generating the topology model 512 based on data or information obtained from an inspective of the live network packets 404 ensures that the network components 110 and the links 304 of the network 108 included in the topology model 512 are current and accurate.

It has been discovered that generating the corrective action 420 for addressing the network anomaly 416 provides for an improved use experience. The user such as a network administrator can better manage the operation of the network 108 by applying the corrective action 420 directly on the live topology 302. The user can also more intuitively understand the effects of the corrective action 420 by seeing the results of the corrective action 420 on the network 108 through an updated instance of the live topology 302.

It has been discovered that generating the live topology 302 based on the topology model 512 provides for a faster and more efficient generation of the live topology 302. The network system 100 can obtain the necessary device and connectivity information from the topology model 512 rather than having to continuously probe the network components 110 for such information prior to generating the live topology 302.

It has further been discovered that generating the live topology 302 based on the topology model 512 provides for a more efficient and cost-effective way to optimize an organization's existing network devices. The organization can use the live topology 302 to structure or restructure the topology of the organization's network to prevent or reduce instances of the network anomaly 416 from adversely affecting the organization's network. The network system 100 also allows the organization to more effectively use its existing network devices rather than purchase additional devices to maintain its network.

It has been discovered that displaying the live traffic flow 402 on the live topology 302 provides for an improved way of detecting for violations of network rules and policies. A user of the network system 100 can quickly recognize a violation of such rules or policies by visually perceiving abnormal traffic flows on the live topology 302.

The network system 100 has been described with module functions or order as an example. The network system 100 can partition the modules differently or order the modules differently. For example, the DPI module 604, the run state module 606, the probing module 608, or a combination thereof can be stand-alone modules separate from the topology sensor module 602.

The modules describes in this application can be ordered or partitioned differently. For example, certain modules can be combined. Each of the modules can also operate individually and independently of the other modules. Furthermore, data generated in one module can be used by another module without being directly coupled to each other.

The modules described in this application can be implemented by hardware circuitry or hardware acceleration units (not shown) in the control units. The modules described in this application can also be implemented by separate hardware units (not shown), including hardware circuitry, outside the control units but with the first device 102 or the second device 106.

For illustrative purposes, the various modules have been described as being specific to the first device 102, the second device 106, or a combination thereof. However, it is understood that the modules can be distributed differently. For example, the various modules can be implemented in a different device, or the functionalities of the modules can be distributed across multiple devices.

The modules described in this application can be implemented as instructions stored on a non-transitory computer readable medium to be executed by a first control unit 212, the second control unit 234, or a combination thereof. The non-transitory computer medium can include the first storage unit 214, the second storage unit 246, or a combination thereof. The first storage unit 214, the second storage unit 246, or a combination thereof, or a portion therein can also be made removable from the first device 102, the second device 106, or a combination thereof.

The non-transitory computer readable medium can include non-volatile memory, such as a hard disk drive, non-volatile random access memory (NVRAM), solid-state storage device (SSD), compact disk (CD), digital video disk (DVD), or universal serial bus (USB) flash memory devices. The non-transitory computer readable medium can be integrated as a part of the navigation system 100 or installed as a removable portion of the navigation system 100.

As a more specific example, one or more modules described above can be stored in the non-transitory memory medium for distribution to a different system, a different device, a different user, or a combination thereof. Also as a more specific example, the modules described above can be implemented or stored using a single hardware unit, such as a chip or a processor, or across multiple hardware units.

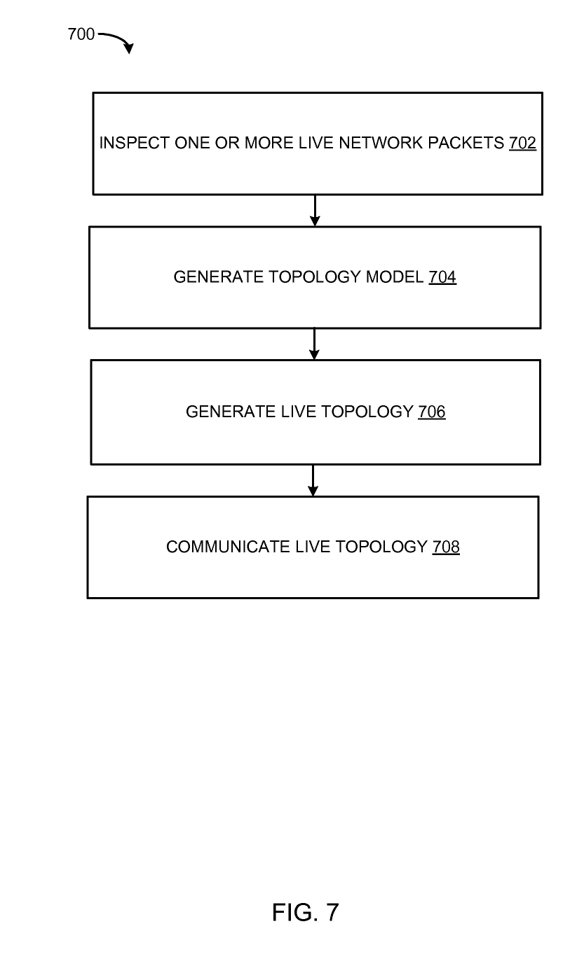

Referring now to FIG. 7, therein is shown an exemplary flow chart of a method 700 of operation of the network system 100 of FIG. 1 in a further embodiment. In one example embodiment, the network system 100 can implement the control flow of FIG. 6.

The method 700 can include inspecting, with the first control unit 212 of FIG. 2, one or more of the live network packets 404 of FIG. 4 including one or more of the live data packets 406 of FIG. 4 and the live service packets 408 of FIG. 4 being transmitted through the network 108 of FIG. 1 in a block 700. The method 700 can also include generating the topology model 512 of FIG. 5 for mapping the network 108 based on the topology attributes 514 of FIG. 5 obtained from the live network packets 404 in a block 704.

The method 700 can further include generating the live topology 302 representing the network 108 based on the topology model 512 and the live network packets 404 in a block 706. The method 700 can further include communicating, with the communication interface 228 of FIG. 2, the live topology 302 to a device in a block 708.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the embodiment of the present invention is that it valuably supports and services the historical trend of reducing costs, simplifying systems, and increasing performance. These and other valuable aspects of the embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A network system comprising:
a control unit configured to:
inspect one or more live network packets including one or more live data packets and live service packets being transmitted through a network;
generate a topology model for mapping the network based on topology attributes obtained from the live network packets;
generate a live topology representing the network based on the topology model and the live network packets; and
a communication interface, coupled to the control unit, configured to communicate the live topology to a device.

2. The system as claimed in claim 1 wherein the control unit is further configured to:
calculate one or more modeled behaviors based on one or more device models, user models, and traffic models; and
determine a network anomaly associated with the network based on the modeled behaviors.

3. The system as claimed in claim 1 further comprising a display interface, coupled to the control unit, configured to display the live topology including a live traffic flow.

4. The system as claimed in claim 1 further comprising a display interface, coupled to the control unit, configured to:
display the live topology; and
display an alert concerning a network anomaly on the live topology for identifying one or more network components associated with the network anomaly.

5. The system as claimed in claim 1 wherein the control unit is further configured to:
generate one or more user models, device models, and traffic models based on the live data packets; and
generate the topology model based on the device models, the traffic models, and the user models.

6. The system as claimed in claim 1 wherein the control unit is further configured to:
generate one or more user models, device models, and traffic models based on the live network packets;
determine a network anomaly associated with the network; and
generate a corrective action for addressing the network anomaly based on the user models, the device models, and the traffic models.

7. The system as claimed in claim 1 wherein the control unit is further configured to:
identify a policy change for changing a network policy of the network;
apply the policy change to the network through the live topology; and
generate the live topology based on the policy change.

8. A method of operation of a network system comprising:
inspecting, with a control unit, one or more live network packets including one or more live data packets and live service packets being transmitted through a network;
generating a topology model for mapping the network based on topology attributes obtained from the live network packets;
generating a live topology representing the network based on the topology model and the live network packets; and
communicating the live topology to a device.

9. The method as claimed in claim 8 further comprising:
calculating one or more modeled behaviors based on one or more device models, user models, and traffic models; and
determining a network anomaly associated with the network based on the modeled behaviors.

10. The method as claimed in claim 8 further comprising displaying, with a display interface, the live topology including a live traffic flow.

11. The method as claimed in claim 8 further comprising:
displaying, with a display interface, the live topology; and
displaying an alert concerning a network anomaly on the live topology for identifying one or more network components associated with the network anomaly.

12. The method as claimed in claim 8 further comprising:
generating one or more user models, device models, and traffic models based on the live data packets; and
generating the topology model based on the device models, the traffic models, and the user models.

13. The method as claimed in claim 8 further comprising:
generating one or more user models, device models, and traffic models based on the live network packets;
determining a network anomaly associated with the network; and
generating a corrective action for addressing the network anomaly based on the user models, the device models, and the traffic models.

14. The method as claimed in claim 8 further comprising:
identifying a policy change for changing a network policy of the network;
applying the policy change to the network through the live topology; and
generating the live topology based on the policy change.

15. A non-transitory computer readable medium including instructions for execution, comprising:
inspecting one or more live network packets including one or more live data packets and live service packets being transmitted through a network;
generating a topology model for mapping the network based on topology attributes obtained from the live network packets;
generating a live topology representing the network based on the topology model and the live network packets; and
communicating the live topology to a device.

16. The non-transitory computer readable medium as claimed in claim 15 further comprising:
calculating one or more modeled behaviors based on one or more device models, user models, and traffic models; and
determining a network anomaly associated with the network based on the modeled behaviors.

17. The non-transitory computer readable medium as claimed in claim 15 further comprising displaying the live topology including a live traffic flow.

18. The non-transitory computer readable medium as claimed in claim 15 further comprising:
displaying the live topology; and
displaying an alert concerning a network anomaly on the live topology for identifying one or more network components associated with the network anomaly.

19. The non-transitory computer readable medium as claimed in claim 15 further comprising:
generating one or more user models, device models, and traffic models based on the live data packets; and
generating the topology model based on the device models, the traffic models, and the user models.

20. The non-transitory computer readable medium as claimed in claim 15 further comprising:
generating one or more user models, device models, and traffic models based on the live network packets;
determining a network anomaly associated with the network; and
generating a corrective action for addressing the network anomaly based on the user models, the device models, and the traffic models.
